(19) United States
(12) Patent Application Publication
(10) Pub. No.: US 2010/0030611 A1
(43) Pub. Date: Feb. 4, 2010

(54) System and apparatus to renovate and market mobile home after chattel mortgage default

(76) Inventors: Thomas L. Long, Paradise Valley, AZ (US); Justin T. Long, Phoenix, AZ (US)

Correspondence Address: TOD R NISSLE, PO BOX 55630, PHOENIX, AZ, 85078, US

(21) Appl. No.: 12/221,288

(22) Filed: Aug. 1, 2008

(51) Int. Cl. G06Q 10/00

(52) U.S. Cl. 705/9

(57) ABSTRACT

A system facilitate the granting of a chattel mortgage and encourages the renovation and marketing of a mobile home after default on a chattel mortgage. A mortgage company grants a chattel mortgage on the mobile home including a monthly payment comprising a renovation fee. The mortgage company pays the renovation fee to a renovation company that renovates the mobile home after default of the chattel mortgage. The renovation company utilizes a renovation procedure that minimizes repair costs.

This invention relates to the renovation and marketing of a chattel.

More particularly, the invention relates to the renovation and marketing of a mobile home following the default of a chattel mortgage on the mobile home.

At present, the mobile home industry appears to be a contracting, possibly dying, industry. In 1993, approximately 250,000 mobile homes were manufactured in the United States; in 1998, approximately 370,000 mobile homes were manufactured in the United States; in 2000, approximately 250,000 mobile homes were manufactured; and, in 2007 about 95,000 mobile homes were manufactured, with limited expectation of a change in this trend.

The principal reason for this trend is the large number of chattel mortgage defaults that have been occurring beginning in about the 2000 to 2001 time frame, and continuing to present day. As a result, mortgage companies have made it much more difficult to obtain chattel mortgages for mobile homes. Prior to 2000, about 70% of mobile home loans were chattel mortgages for mobile homes in mobile home communities. The other 30% of mobile home loans were for mobile homes on and tied to a parcel of land outside of a mobile home community. Currently, these numbers are reversed. Seventy percent of loans are for mobile homes on a parcel of land that is tied to the mobile home. The remaining 30% of loans are chattel mortgages for mobile homes in a mobile home community, which loans require a higher interest rate and down payment.

Although the downward trend of mobile home sales has continued since the 2000-2001 time frame, the market appears content with the status quo and hopes that the landscape will change and that a market-saving process will somehow spontaneously generate. One attempt that has been made to solve the reluctance of lenders to provide mobile home chattel mortgages is the tendency of mobile home community owners to offer fixed long term leases and to have a reasonable code of conduct that must be adhered to by a mobile home owner. This procedure sometimes encourages a lender to grant a mobile home mortgage; however, the downward spiral of mobile home sales has continued.

Accordingly, it would be highly desirable to provide an improved system to promote the granting of chattel mortgages for mobile homes.

Therefore, it is a principal object of the instant invention to provide an improved system to renovate and market a mobile home after a chattel mortgage default.

These and other, further and more specific objects and advantages of the invention will be apparent to those skilled in the art from the following detailed description thereof, taken in conjunction with the drawings, in which:

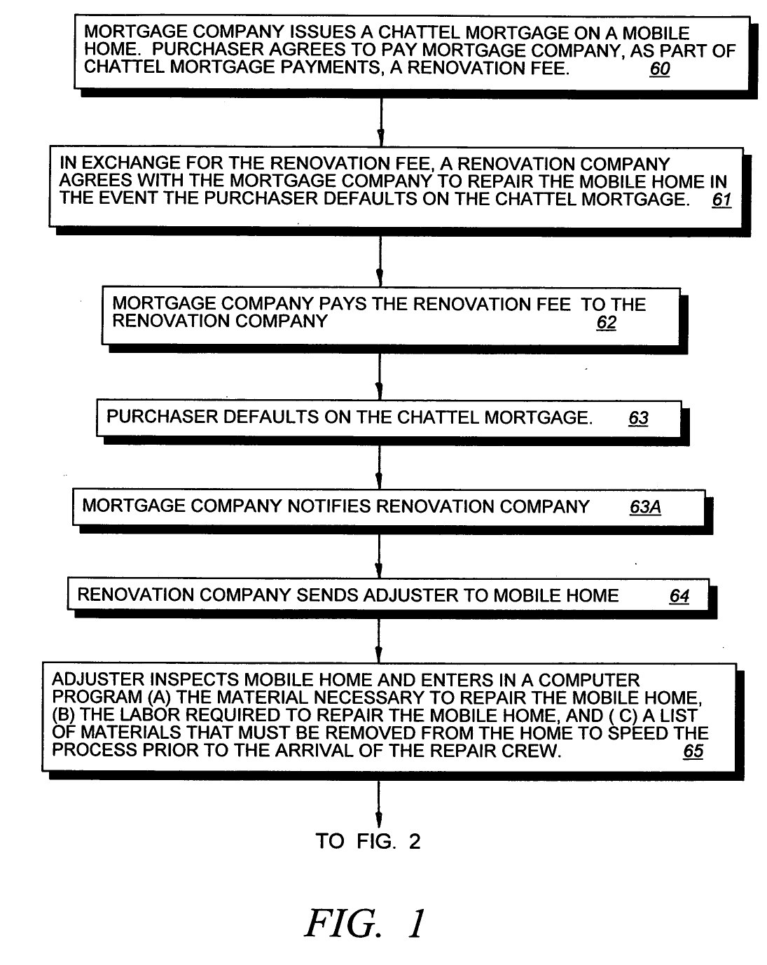

FIG. 1 is a block flow diagram illustrating an embodiment of the invention; and,

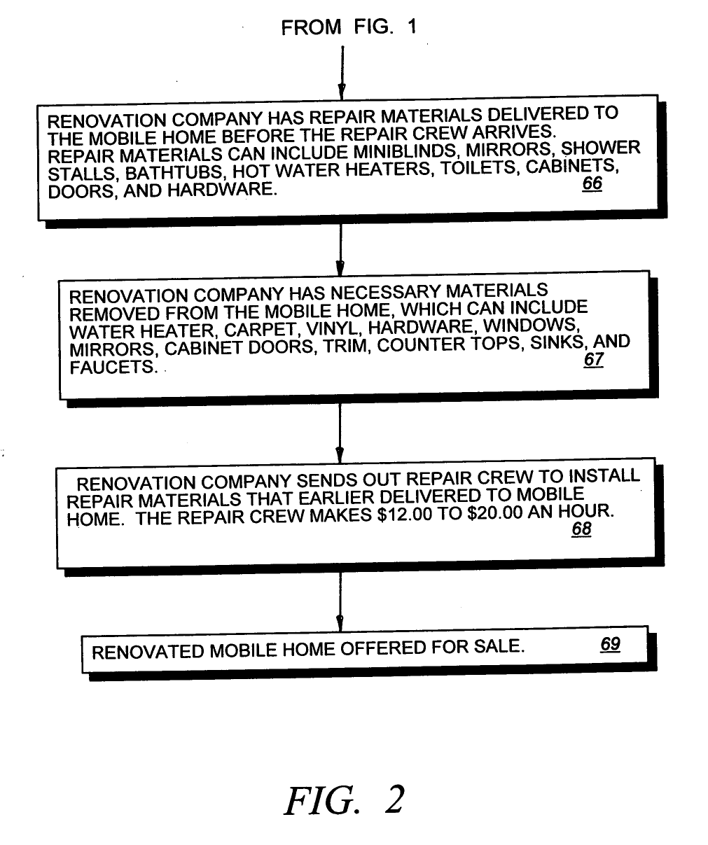

FIG. 2 is a block flow diagram further illustrating the embodiment of the invention of FIG. 1.

Briefly, in accordance with the invention, provided is an improved system to facilitate the granting of a chattel mortgage by facilitating the renovation and marketing of a mobile home in a mobile home park in a metropolitan area after default on a chattel mortgage. The system comprises the steps of having a mortgage company grant a chattel mortgage on the mobile home including a payment comprising a renovation fee; having the mortgage company pay the renovation fee to a renovation company which agrees with the mortgage company to renovate the mobile home after default of the chattel mortgage; after default of the chattel mortgage, having the renovation company as part of its agreement renovate the mobile home. The renovation company sends an adjuster to the mobile home; has the adjuster inspect the mobile home and enter into a computer the repair materials necessary to repair the mobile home, the labor required to repair the mobile home, and the materials required to be removed from the mobile home prior to repair; delivers to the mobile home the repair materials; and, has a repair crew, after delivery of the materials necessary to repair the mobile home, visit the mobile home and use the repair materials to repair the mobile home.

Turning now to the drawings, which depict the presently preferred embodiments of the invention for the purpose of illustrating the practice thereof and not by way of limitation of the scope of the invention and in which like reference characters refer to corresponding elements throughout the several views, FIGS. 1 and 2 illustrate presently preferred embodiments of the invention.

The first step 60 in the system of the invention is for a mortgage company to issue a chattel mortgage on a mobile home. As part of the mortgage agreement, the purchaser agrees to pay the mortgage company a renovation fee. The renovation fee typically is paid continuously to the mortgage company as part of each monthly mortgage payment by the purchaser, this to insure that the renovation fee is paid. The renovation fee can, however, be paid annually or in any other desired manner. The amount of the renovation fee is sufficient for a renovation company both to meet its obligations to renovate a mobile home after to default and to provide the renovation company with a profit. While the amount of the renovation fee can vary as desired due to inflation and other factors, it is presently anticipated that the renovation fee will be in the range of $60.00 to $120.00 a month.

The next step 61 in the system of the invention is for a renovation company to agree, in exchange for the renovation fee, with the mortgage company to be responsible for the renovation of a mobile home in the event the purchaser defaults on the chattel mortgage. The renovation fee can be paid at any desired time(s), annually, biannually, etc. It is presently anticipated that the renovation fee will be paid to the renovation company monthly, after the mortgage company receives the monthly mortgage payment from the purchaser of the mobile home. The mortgage company and renovation company agree on the particular repairs for which the renovation company is responsible. For example, the renovation company can agree to repair or replace of mini-blinds, mirrors, shower stalls, bathtubs, hot water heaters, toilets, cabinets, doors, and associated hardware. On the other hand, the renovation company may have no responsibility in the event the purchaser burns down (hopefully accidentally) the mobile home.

The next step 62 in the system of the invention is for the mortgage company to pay the renovation company the agreed upon renovation fee.

The next step 63 in the system of the invention is for the purchaser to default on the chattel mortgage.

In the next step 64 of the system of the invention, the mortgage company notifies the renovation company of the default of the chattel mortgage and the renovation company sends an adjuster to the mobile home. The adjuster can be an employee of the renovation company or an independent contractor hired by the renovation company.

During step 65, the adjuster inspects the mobile home and enters in a computer program (a) the material necessary to repair the mobile home, (b) the labor required to repair the mobile home, and (c) a list of materials that must be removed from the mobile home prior to the arrival of the repair crew in order to speed the repair process. The adjuster can enter this information in a lap top computer or other computer that he carries with him, or can make hand written notations of the information and enter the information in a computer on the adjuster's return to his home or place of business. It is preferred that the information be entered directly into a computer that the adjuster has at his disposal at the mobile home. The information or a portion thereof so entered by the adjuster is then preferably, but not necessarily, transmitted to at least one other computer. For example, the list of materials necessary to repair the mobile home can be transmitted via the Internet to a company that the renovation company has contracted to provide and deliver the repair materials, the list of materials to be removed from the mobile home can be transmitted to a company that the renovation company has contracted to remove materials from the mobile home, and, the list of necessary repairs can be transmitted to a company that the renovation company has contracted to perform the necessary repairs. Or, the list of materials to be removed can be transmitted to a computer (and/or printer) in the renovation company that is utilized by employees of the renovation company that specialize in removing materials from a mobile home; the list of necessary repair materials can be transmitted to a computer (and/or printer) in the renovation company that is utilized by employees of the renovation company that specialize in delivery necessary repair materials; and, the list of necessary repairs can be transmitted to a computer (and/or printer) in the renovation company that is utilized by employees of the renovation company that specialize in carrying out repairs in mobile homes. The dispersing of material removal, repair material delivery, and repair tasks is important in the practice of the invention because repair delivery individuals normally are paid less than material removal individuals, and, material removal individuals normally are paid less than individuals that actually carry out the repairs. Further the computerized dispersal or other dispersal of information collected by the adjuster to appropriate other locations (i.e., the delivery crew/company or the material removal crew/company or the repair crew/company) is important in the practice of the invention.

During step 66, the renovation company has the repair materials identified by the adjuster delivered to the mobile home before the repair crew arrives. As used herein, “before the repair crew arrives” can mean before or at the same time the repair crew arrives. In order to reduce the time on site of the repair crew, it is important that the repair crew not be on site waiting for repair materials to arrive. Similarly, step 67 is carried out before the repair crew arrives.

During step 67 damaged materials or other materials that are being replaced are removed from the mobile home. Such materials can, by way of example and not limitation, include water heater, carpet, vinyl, hardware, windows, mirrors, cabinet doors, trim, counter tops, sinks and faucets.

Finally, after repair materials have been delivered in step 66 and the necessary materials have been removed from the mobile home in step 67, a repair crew is dispatched to the mobile home in step 68 to utilize the repair materials to renovate the mobile home.

After the renovation company completes repair of the mobile home, the mobile home is offered for resale 69 or, possibly, is leased.

Prior to the system of the invention, a mortgage company could lose up to 70% or more of the total principal remaining on a mobile home when the mobile home owner defaulted on his or her chattel mortgage. With the system of the invention, it is believed that a mortgage company more likely would lose only 15% of the total principal or, make, and not lose, money.

Development of the invention required a specific focus on mobile homes in mobile home communities with chattel mortgages. Since mobile homes are not permanently affixed to the land In a mobile home community, the purchase of such mobile homes requires a chattel mortgage. There doubtless are many, likely millions, of instances where mobile homes rest on and are permanently affixed to a larger parcel of land and therefore become part of the real estates; however, the type of mortgage utilized to finance such permanently affixed mobile homes is not in the purview of the invention, and trends or practices in connection with such mobile homes may contradict or obfuscate teachings and practices in connection with mobile home chattel mortgages. As used herein a mobile home community is an area of land including at least ten usually small (in comparison to the size of parcels on which most “fixed” 2, 3, 4 bedroom conventional construction suburb homes are built), separate parcels of land that each are leased to a mobile home owner and that each include electrical, water, and sewer hookups for a mobile home.

For many years, mortgages have been granted on mobile homes that are in a wide variety of locations including cities, small towns, woodlands, deserts, suburbs, etc. At first blush, PIC common sense can suggest that the system of the invention can be utilized anywhere, just as mortgages have for many years been granted for mobile homes located just about anywhere. During development of the invention, it was determined, and is believed, that the system of the invention is, for best effect and practicality, limited to metropolitan areas. As utilized herein, a metropolitan area is a city with a population of at least 10,000 people.

Unless reasons exist to the contrary, judicial notice is taken of the following facts:
1. There is a long felt dominant trend for mortgage companies to be reluctant to provide chattel loans to purchase mobile homes because (1) when an owner defaults, the mobile home typically has suffered damage and can't be sold for a high enough price for the mortgage company to recoup its investment, (2) higher foreclosure rates accentuate losses throughout the portfolio of a mortgage company. A mortgage company could lose about 70% of the total principal when a mobile home owner defaults on his or her chattel mortgage.
2. There is a long felt dominant trend for mortgage companies not to arrange for repair of a mobile home after a purchaser has defaulted on the mortgage. One reason for this that has existed for a much longer period of time is that mortgage companies are interested in loaning money and not being in the construction business. Mortgage companies don't have the personal to arrange for or conduct construction repairs, don't know how to operate large constructions projects, and have no interest in such.
3. There is a long felt dominant trend for a mobile home repair crew to arrive at a mobile home before the necessary repair materials arrive at the mobile home.
4. There is a long felt dominant trend for the same crew that repairs a mobile home to locate, acquire, and deliver the necessary repair materials.
5. There is a long felt dominant trend in connection with the repair of a mobile home to not detail necessary repairs, materials, and work crews and enter and delineate the same in a computer.
6. One particular unexpected and unpredicted benefit discovered after the invention was developed is that it significantly reduces the cost of repairing a mobile home after a purchaser defaults.
7. Another unexpected and unpredicted benefit discovered after the invention was developed is that the use of separate adjustor, delivery methods, and repair crews reduces the time required to repair a mobile home. PIC (People in Common) common sense might initially suggest that the use of more crews would increase the time required to complete repairs of a mobile home. This is due to specialization and diversified labor concepts.
8. There is no identified problem in the mobile home mortgaging art that provided sufficient impetus for the development of the invention. Conventional mortgaging and repair methods have long been accepted, and the general attitude of people in the relevant market was to accept the status quo and hope that the landscape would change for the better.
9. There is no identified problem in the mobile home mortgaging art that suggests a readily apparent specific set of solutions, one of which is the invention. Conventional mobile home mortgaging and repair methods have long been accepted, and the general attitude of people in the relevant market was to accept the status quo and hope that the landscape would change for the better.
10. There is no identified motivation in the mobile home mortgaging art that provided sufficient impetus for the development of the invention. Conventional mortgaging and repair methods have long been accepted.
11. Common sense judgment requires that valid reasoning justifying such judgment be set forth.
12. The TSM test, per KSR, can provide helpful insight into evaluating the obviousness of the invention.
13. There is no reason not to use the TSM test in evaluating the obviousness of the invention described and claimed herein.
14. Motivation. Making something better is a broad, general, long-existing motivation that applies to each invention. Broad, general, long-existing motivations likely provide little significant impetus to produce an invention. For example, in the exercise machine art, one broad, general, long-existing motivation is to make exercise machines versatile, so that more than one exercise can be produced on an exercise machine. This motivation typically provides little significant impetus to produce an invention. If, on the other hand, an exercise machine produces a greater than normal number of injuries, such a problem is more specific and provides stronger impetus to improve the machine.
15. Assessing Weight Accorded a Problem or Motivation. The weight or importance of a problem or motivation in leading to an invention is apprised by evaluating by (1) how long the problem has existed, (2) the importance, and hence the driving force, of the problem or motivation, (3) whether the problem or motivation reasonably suggests the invention, (4) whether the motivation reasonably suggests a set of solutions of which the invention is one, (5) the trends, if any, produced by the problem or motivation, and (6) other solutions produced in response to the motivation or problem. With respect to (1) above in this paragraph, if a problem has long existed without producing a solution, that suggests the invention is not obvious. With respect to (2) above in this paragraph, if the problem appears to have little significance, that suggests it is not driving those of skill in the art toward the invention. With respect to (3) above, if the problem suggests a solution other than the invention, this suggests the problem is not driving those of skill in the art toward the invention. With respect to (4) above in this paragraph, if the problem suggests a set of solutions other than the invention, this suggests the problem is not leading toward the invention. With respect to (5) above, if the prevailing trends lead away from the invention or reinforce other solutions to the invention, that suggests the problem has not presented the invention as a solution. With respect to (6) above in this paragraph, other solutions may reinforce the idea that the art is satisfied with the status quo and not interested in alternate solutions.
16. Common Sense. Proposed definitions of common sense are set forth below.

A. The People in Common (PIC) Definition: “The Earth is Flat”.

One definition of common sense is what people in common would agree upon, that which they “sense” as their common natural understanding or would consider in most people's experience to be prudent and of sound judgment. This definition assumes a country with a population with a particular baseline language, customs and knowledge. The baseline knowledge is knowledge available and known by a large majority of the population, and is knowledge that typically does not require specialized knowledge or study; such baseline knowledge can change over time depending on the success of educational institutions, changing societal climes, etc. Under the people in common (PIC) definition, common sense often has been wrong and, for example, at one time held that the earth was flat. Even today it evidently is estimated that 60% of the people on earth believe the sun revolves around the earth. Others today use “common sense” to make the judgment that heavier bodies fall faster than light bodies.

B. The Common Man Sound Judgment (CMSJ) Definition.

A second definition of common sense is sound judgment based on a simple perception of the situation or facts. Sound judgment means sensible judgment based on valid reasoning. This suggests that a common sense judgment, if reliable, is subject to evaluation to see if there are reasons or criteria that support and justify the judgment. This definition assumes a country with a population with a particular baseline language, customs and knowledge. The baseline knowledge is knowledge available and known by a large majority of the population, and is knowledge that typically does not require specialized knowledge or study; such baseline knowledge can change overtime depending on the success of educational institutions, changing societal climes, etc. What might be common sense to an American might not be common sense to a person living in another country. An individual could move to the United States from India and what might appear common sense to an American would, because of the culture of India, make absolutely no sense to the Indian. In evaluating obviousness, however, it is usually, for better or worse, assumed that the Indian has the same baseline knowledge as individuals who have grown up in the United States.

C. The Ordinary Skill Sound Judgment (OSSJ) Definition.

A third definition of common sense is sound judgment by one of ordinary skill in the art based on a perception of the situation or facts in the context of the baseline knowledge in CMSJ and of specialized knowledge that is over and above said baseline knowledge and is attributed to one of ordinary skill in the art. As noted, sound judgment means sensible judgment based on valid reasoning. This suggests that a common sense judgment by one or ordinary skill in the art is, if reliable, subject to evaluation to see if there are reasons or criteria that support and justify the judgment. This definition assumes a country with a population with a particular baseline language, customs and knowledge. The baseline knowledge and specialized knowledge comprise knowledge available and known by a large majority of those of skill in the art; such baseline knowledge and specialized knowledge can change over time depending on the success of educational institutions, advances in the art, changing societal climes, etc. What might be common sense to an American of ordinary skill in the art might not be common sense to a person that lives in another country and appears to be one of ordinary skill in the art. In evaluating obviousness, however, it is usually, for better or worse, assumed that the person of ordinary skill in the art from India has the same baseline knowledge as individuals of skill in the art who have grown up in the United States. In some technically simple inventions, the ordinary skill sound judgment (OSSJ) may be commensurate with common man sound judgment (CMSJ) because there is little if any specialized knowledge required. For example, a new Christmas tree ornament design might not require any particular specialized knowledge over and above the baseline knowledge of the large majority of people. In contrast, many inventions obviously require a specialized knowledge over and above commonly held baseline knowledge, in which case such specialized knowledge will be utilized in the sound reasoning involved in ordinary skill sound judgment common sense.

As used herein, relying on common sense judgment requires that valid reasoning justifying such judgment be set forth. Hence, the common man sound judgment (CMSJ) and ordinary skill sound judgment (OSSJ) definitions are generally relied on herein in determining the obviousness of an invention.
17. Assessment of Trends. As used herein a trend is a general inclination or tendency. A trend generally (1) occurs over an extended period of time, (2) occurs by or within a large number of individuals in the pertinent art, and (3) often can be demonstrated by the existence of a significant number of printed references and by personal knowledge of those in the art. With respect to (1) above in this paragraph, a general inclination that lasts a short period of time, for example a day or a month, typically does not constitute a trend. With respect to (2) above in this paragraph, if only a few individuals demonstrate a general inclination or tendency, such typically does not comprise a trend. With respect to (3) above in this paragraph, if there are only a few documents that demonstrate a particular inclination or tendency, such typically does not demonstrate a trend.

The weight or importance of a trend in leading to an invention is evaluated by assessing (1) the length of time during which the trend has existed, (2) the number of individuals that believed or followed the trend, (3) the number of references that describe the trend, (4) the existence of other similar or related trends that might obfuscate or invalidate a trend and make it unlikely to lead to the invention, and (5) the existence of countervailing trends. If a trend is “buried” among many comparable trends in the art, it becomes more unlikely that one of ordinary skill will notice or utilize the trend. If a trend is overshadowed by countervailing trends, it becomes more unlikely that one of ordinary skill will notice or utilize the trend.
18. Assessing an Equivalent. As used herein, an equivalent is a structure or a system that is functionally or structurally equivalent to another structure or system. In determining whether it is obvious to substitute one “equivalent” for another, the following must be evaluated. First, is what is being substituted truly an equivalent? Is it functionally or structurally equivalent to what is being replaced? Second, if the equivalent is functionally or structurally equivalent, is it only structurally equivalent or only functionally equivalent? If it is only one or the other, this reduces the likelihood the equivalent would be used. Third, did the equivalent, or the invention, have to be modified to use the equivalent? If so, this reduces the likelihood the equivalent would be utilized. Fourth, is it likely the equivalent would be considered by one of ordinary skill in the art? If a new Christmas ornament utilizes a laminate including an outer protection coating from a prior Christmas ornament and substitutes that coating as an “equivalent” for the outer protective coating in another known Christmas ornament, then it arguably is likely that such a substitution would be considered by one of skill in the art. On the other hand, if the first substitute coating is normally found in a nuclear reactor in a submarine, it may be very unlikely, almost incredible, that such a coating would be considered and a substitution would be made. Simply stating that it would be known by one of skill in the art to substitute an equivalent is not, without providing reasons, believed sufficient. Otherwise such a generalized rationale could be used to invalidate most, if not all, patents known to man.
19. The benefits of the invention are wide ranging. First, reducing the risk to mortgage companies means that more chattel mortgages will be granted, and that the financial terms necessary for a buyer to qualify for a chattel mortgage will be eased. Second, purchasers will, as noted, benefit because it will be easier for them to qualify for a loan. Third, the manufacturers of mobile homes will benefit because they will be able to produce more mobile homes. Fourth, retailers of mobile homes will benefit because they will be able to sell more mobile homes. Fifth, the economy of the United States will benefit because the damage caused by a defaulted chattel mortgage will be significantly lessened. Sixth, mobile home communities will be able to reduce vacancy rates while providing low to moderate cost housing. Seventh, there will be a reduction in the number of personnel required in the repossession department of the mortgage company. Eighth, in order to increase sales, manufacturers, retailers, and mobile home community owners will be more interested in participating in price reductions to subsidize the monthly cost incurred by the purchaser of a mobile home.
20. A mobile home community is an area of land including at least ten separate parcels of land that are—in comparison to the size of parcels on which most “fixed” 2, 3, 4 bedroom conventional construction suburb homes are built-usually small, are each leased to a mobile home owner, and each include electrical, water, and sewer hookups for a mobile home.
21. A metropolitan area is a city with a population of at least 10,000 people.
22. A mobile home chattel mortgage is a loan by a lender to a borrower for the borrower to purchase a mobile home. The loan usually includes specified payment periods and interest rates. The borrower gives the lender a lien (security interest) on the mobile home as collateral for the loan.
23. The annual sale of mobile homes steadily decreased from about 250,000 in the 2000-2001 time frame to 95,000 in 2007.
24. It presently, in July 2008, is difficult to obtain a chattel mortgage for a mobile home unless you have a sufficiently high credit rating or down payment.
25. Presently, in July 2008, approximately 70% of mobile home loans are for mobile homes attached to a piece of land, and approximately 30% of mobile home loans are chattel mortgages.
26. Mortgages have for many years been granted for mobile homes located in a wide variety of areas including cities, small towns, wood lands, deserts, suburbs, and mobile home communities.

Having set forth our invention in terms to enable those skilled in the art to understand and practice the invention and having set forth the presently preferred embodiments and uses thereof, we Claim:

1. A system to facilitate the granting of a chattel mortgage by facilitating the renovation and marketing of a mobile home in a mobile home park in a metropolitan area after default on a chattel mortgage, comprising the steps of
(a) a mortgage company granting a chattel mortgage on the mobile home in the mobile home park in the metropolitan area, the chattel mortgage including and requiring a monthly payment comprising a renovation fee;
(b) payment by the mortgage company of the renovation fee to a renovation company which agrees with the mortgage company to renovate the mobile home after default of the chattel mortgage;
(c) after default of the chattel mortgage, renovation of the mobile home by the renovation company as part of its agreement with the mortgage company, said renovation of the mobile home comprising
(i) dispatching an adjuster to the mobile home,
(ii) inspection by the adjuster of the mobile home and entry by the adjuster into a computer of
the repair materials necessary to repair the mobile home,
the labor required to repair the mobile home, and
the replaceable materials required to be removed from the mobile home prior to repair,
(iii) delivery to the mobile home of the repair materials,
(iv) sending a first removal crew to the mobile home after delivery of the material necessary to repair the mobile home, said first removal crew removing said replaceable materials.
(v) sending a second repair crew to the mobile home after delivery of the materials necessary to repair the mobile home,
(vi) repair, with the repair materials, of the mobile home by the second repair crew, individuals comprising said first removal crew being paid less than individuals comprising said second repair crew.
